(19) United States
(12) Patent Application Publication
(10) Pub. No.: US 2015/0225079 A1
(43) Pub. Date: Aug. 13, 2015

(54) REMOTELY OR AUTONOMOUSLY PILOTED REDUCED SIZE AIRCRAFT WITH VERTICAL TAKE-OFF AND LANDING CAPABILITIES

(71) Applicants: Douglas L. Starck, Las Vegas, NV (US); Errica M. Starck, Las Vegas, NV (US)

(72) Inventors: Douglas L. Starck, Las Vegas, NV (US); Errica M. Starck, Las Vegas, NV (US)

(73) Assignee: Starck Engineering, LLC, Las Vegas, NV (US)

(21) Appl. No.: 14/054,080

(22) Filed: Oct. 15, 2013

(51) Int. Cl. B64C 29/00; B64C 39/10; B64D 27/16

(52) U.S. Cl. CPC B64C 29/0025; B64D 27/16; B64C 39/10; B64C 2039/105

(57) ABSTRACT

An aircraft having a vertical take-off and landing (“VTOL”) propulsion system aircraft, smaller than a standard manned aircraft and remotely or autonomously piloted. The aircraft comprises a symmetrical airfoil shape for the center body section that consists of ribs and spars maintaining an open area in the center. Situated within the open area of the center of the aircraft resides a duct system consisting of a ducted fan and five outlet vents. The main outlet vent functions as the exhaust exiting the aft portion of the aircraft, with the remaining four ducts used for the VTOL capabilities exiting the underside of the aircraft. The aircraft can have a range of wingspan, which can be scaled to satisfy needs and requirements, with a blended wing body that incorporates the inlet and duct system.

### CROSS-REFERENCE TO RELATED APPLICATIONS

None

### FEDERALLY SPONSORED RESEARCH

None

### SEQUENCE LISTING

None

### FIELD OF THE INVENTION

The present invention relates generally to aerodynamic bodies and, more particularly, to aerodynamic bodies being smaller than standard aircraft and being remotely or autonomously piloted with vertical take-off and landing capabilities.

### BACKGROUND

There are a variety of existing vertical take-off and landing (“VTOL”) aircraft in use today. For example, helicopters are VTOL aircraft. However, because of its retreating blade and its basic construction the forward flight speed and efficiency of a conventional helicopter is significantly inferior to that of a conventional fixed wing aircraft. Additionally, the complexity of the helicopter's mechanical linkages contributes significantly to the crafts' high cost and demanding maintenance requirements. More recent efforts to improve the forward flight speed of VOTL aircraft are geared toward articulating rotors and/or wings or other toward other means of vectoring thrust. The tilt rotor aircraft designs attempt to combine the forward flight dynamics of a fixed wing aircraft with the VOTL capabilities of a helicopter. However, tilt rotor aircraft have several distinctive drawbacks. The first notable drawback is that tilt rotor aircraft must overcome negative angular moments created by tilting their spinning rotors ninety (90) degrees during VTOL transitions. These angular moments produce a nose up force when transitioning from vertical to horizontal flight and a nose down force when transitioning from horizontal to vertical flight. These forces create inherently unstable conditions during the transitions between vertical and horizontal flight and visa versa. In actual practice, this inherent instability has been largely responsible for a poor safety record for this type of aircraft. A second drawback of the tilt rotor design is the fact that if the propulsion rotation system should fail the craft is rendered incapable of landing as a conventional fixed wing aircraft. This occurs because the rotors are so large that they would strike the ground if the aircraft were to be landed like a conventional fixed wing aircraft, with the propellers spinning on a horizontal axis.

Still another type of fixed wing VTOL aircraft employs vertically oriented ducted fans or jets in the wing of the craft. This type of aircraft typically suffers from several significant drawbacks. First, if the craft has only a few small fans, high velocity air is required for sufficient thrust thus resulting in the hazards and inefficiencies previously noted for the vectored thrust aircraft. If, however, the fan area is large the area taken by the fans will significantly impair the ability of the wing to develop lift during the transition time, when maximum lift is most needed. Furthermore, if the openings are large, they must be shuttered with louvers in order to reduce the induced drag of the opening during forward flight. This requirement for shuttering the fans during VTOL transitions adds further complexities and instabilities to the aircraft, particularly when transitioning from vertical to horizontal flight and visa-versa. A second major drawback of the fan-in-wing aircraft is that the wings must be thicker than normal in order to house the ducted fans and their associated power transmission or power generation components. The drag induced by the thicker wing geometry will limit forward flight speed and efficiency. There are also non-winged versions of the vertical ducted fan concept. Since these non-winged craft derived the majority of their lifting force from vertical thrust, they are inherently inefficient in regards to forward flight when compared to a conventional fixed wing aircraft.

Still a major drawback of nearly all of the foregoing tilt rotor and tilt-duct designs is that the aircraft is unable to fly at all if one engine should fail. Moreover, the complexity and costliness of such aircraft have been extreme. The aviation industry has long sought to improve these existing tilt-rotor and tilt-duct designs, most importantly improving reliability and safety, speed and range, and reducing or eliminating the risk of stalling. To date the foregoing and all other known attempts have fallen short of at least one of these goals. In addition to the physical requirements of such aircraft, the need for better intelligence gathering techniques is becoming more crucial in today's current environment. The ability to track an enemy in any type of terrain without the need for bulky equipment line the current launch and recovery systems or a clear open space that can be used for a runway would greatly enhance intelligence gathering. The mechanical complexities of implementing and creating a small remotely or autonomously piloted aircraft with VTOL capabilities are substantial. Prior attempts to include VTOL capabilities in a small remotely or autonomously piloted aircraft for guided munitions and other flight options have resulted in designs and schemes that, in the case of air launched and ground launched guided aircraft, are housed outside of the aircraft structure. The VTOL functions and mechanisms are often mounted on the fuselage, for example. As such, the aerodynamic mechanisms of the existing VTOL systems suffer from increased part counts, increased cost and reduced reliability.

One purpose of the proposed invention of the small remotely or autonomously piloted aircraft is to be capable of unobtrusively tracking enemy personal and vehicles. This aircraft will have a unique ability to hover over a target so that images can be captured. The present invention aircraft, generally known as the Starck Engineering 1 (“SE-1”), will have VTOL capabilities with an electric power plant completely inside the aircraft, thus resulting in no exposed moving blades and improved aerodynamics.

### SUMMARY

It is, therefore, an object of the present invention to provide a VTOL propulsion system for a small remotely or autonomously piloted aircraft that employs a distributed duct system to achieve VTOL as well as highly efficient forward flight.

One embodiment of the invention includes a symmetrical airfoil shape for the center body section which creates large amounts of lift at very small angles of attack. Using a blended body design allows the change of the vehicle cross-section from a symmetrical airfoil in the middle of the body transitioning to an asymmetric airfoil shape at the outer wing tip. Construction of the main body of the invention consists of composite ribs and spars maintaining an open area in the center. The outer skin is a three ply stack-up of carbon fiber cloth and pre-impregnated tape giving the SE-1 invention its outer shape. The hollow center of this embodiment of the invention allows for the ability to store large amounts of hardware and assorted sensor packages.

A critical feature of this embodiment is the blended wing body that incorporates the inlet and duct system. The duct system is the basis of the SE-1's VTOL capabilities. The duct system is situated in the middle of the center body and consists of a ducted fan and five outlet vents. The main outlet vent is the exhaust existing out the aft portion of the aircraft. The construction of the duct system is manufactured out of carbon fiber which reduces the weight and increase the strength while allowing manufacturing of complex duct shapes. The duct system allows for a serpentine intake that precludes a direct line of sight of the fan blades thus reducing the radar cross-section (“RCS”). The SE-1 is a tailless aircraft with a blended wing body, anhedral wings, and wing tips that are constructed of composite material. The nonmetallic material used and the size of the SE-1, along with the tailless shaped coupled with the anhedral wings and wing tips further reduce the RCS signature. The reduced undetectability of the SE-1 makes it an ideal platform to observe quietly without being detected. No current designs, or prior art, exist that provide the same functional reconnaissance with a comparable and similar low RCS signature.

Another embodiment of the invention includes an extended tail section located at the aft portion of the aircraft and invention. This embodiment provides the SE-1 the ability to shield any noise propagating from the exhaust towards the ground. This embodiment also includes a pitch stabilizer that will allow the SE-1 to maintain a slight pitch up characteristic during straight and level flight. As the weight increase in the SE-1 the extended tail may be increased to counter the weight as needed.

An embodiment of the invention also includes a method of remotely or autonomously piloting an aerial vehicle. The method includes required elements of a flight control system that consists of engine control unit, sensor package, servos, and VTOL flow valves on an aerial vehicle. The method also includes a microcontroller containing a GPS unit, accelerometer and pressure differential sensors. The microcontroller is used to control and monitor all aspects of the SE-1 during flight.

Finally, the VTOL propulsion system according to the present invention is suitable for use in un-manned small remotely or autonomously piloted aircraft and all the embodiments will be light, easy to transport, simple to assemble/dissemble, and can be launched in the most rugged terrain.

### DESCRIPTION OF DRAWINGS AND FIGURES

Other objects, features, and advantages of the present invention or SE-1 will become more apparent from the following detailed description of the embodiments and certain modifications thereof when taken together with the accompanying drawings in which:

FIG. 1 is a perspective top view of the SE-1 in accordance with one example of the preferred embodiment of the present invention.

FIG. 2 is a perspective side view of the SE-1 in accordance with one example of the preferred embodiment of the present invention.

FIG. 3 is a perspective front view of the SE-1 in accordance with one example of the preferred embodiment of the present invention.

FIG. 4 is a preliminary dimensional layout of the SE-1.

FIG. 5 is an illustration of the symmetric style center body section and location of the inlet and duct system in the center body of the SE-1 in accordance with one example of the preferred embodiment of the present invention.

FIG. 6 is an enlarged perspective illustration of a wing panel.

FIG. 7 is an enlarged perspective illustration of the duct system inlet configuration of the SE-1 in accordance with one example of the preferred embodiment of the present invention.

FIG. 8 is an illustration of the potential velocity contour vectors for an embodiment of the VOTL duct system of the SE-1 in accordance with one example of the preferred embodiment of the present invention.

FIG. 9 is an illustration of the potential laminar duct inlet velocity vectors for an embodiment of the VOTL duct system of the SE-1 in accordance with one example of the preferred embodiment of the present invention.

FIG. 10 is an enlarged perspective illustration of the gate value system used within the SE-1 in accordance with one example of the preferred embodiment of the present invention.

FIG. 11 is a descriptive illustration of the gate value mechanism used inside the SE-1

FIG. 12 is a method diagram of the one alternative embodiment for the flight control system of the SE-1 in accordance with one example of the preferred embodiment of the present invention.

FIG. 13 is an enlarged perspective illustration of one alternative embodiment for flow control valves in various positions from fully open to half opened and finally fully closed.

FIG. 14 is an illustration of the potential velocity contours during takeoff of an embodiment of the SE-1.

FIG. 15 is an illustration of the potential velocity contours during flight transition of an embodiment of the SE-1.

### DETAILED DESCRIPTION

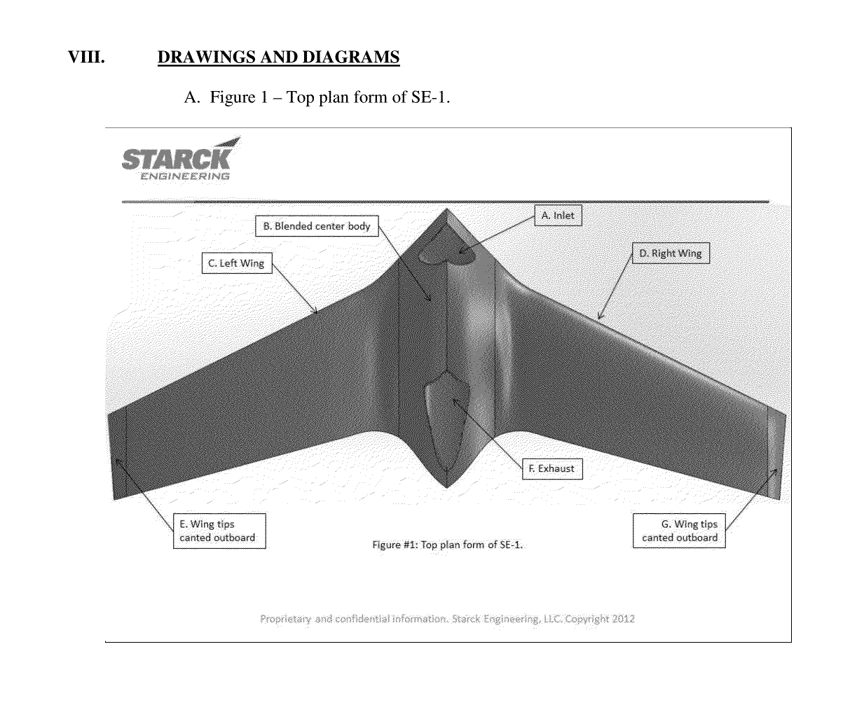

FIG. 1 is a perspective top view of the SE-1 in accordance with one example of the preferred embodiment of the present invention. (A) is an inlet of the preferred embodiment. (B) is a blended center body of the preferred embodiment. (C) is the top-down view of the left wing of the preferred embodiment. (D) is the top-down view of the right wing of the preferred embodiment. (E) is the top-down view of the left wing tips canted outboard of the preferred embodiment. (F) is an exhaust of the preferred embodiment. (G) is the top-down view of the left wing tips canted outboard of the preferred embodiment.

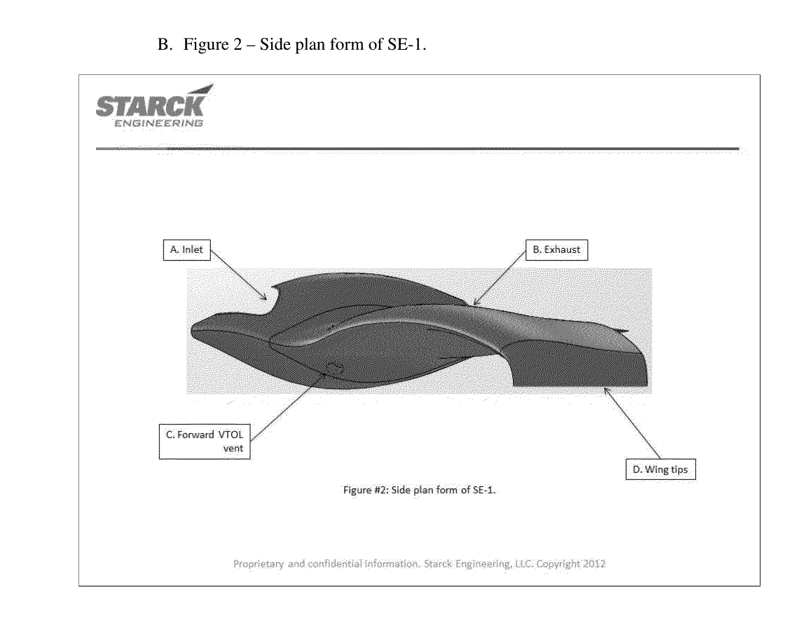

FIG. 2 is a perspective side view of the SE-1 in accordance with one example of the preferred embodiment of the present invention. (A) is an inlet of the preferred embodiment. (B) is an exhaust of the preferred embodiment. (C) is the side view of the left wing forward VTOL vent of the preferred embodiment. (D) is the side view of the left wing tips canted outboard of the preferred embodiment.

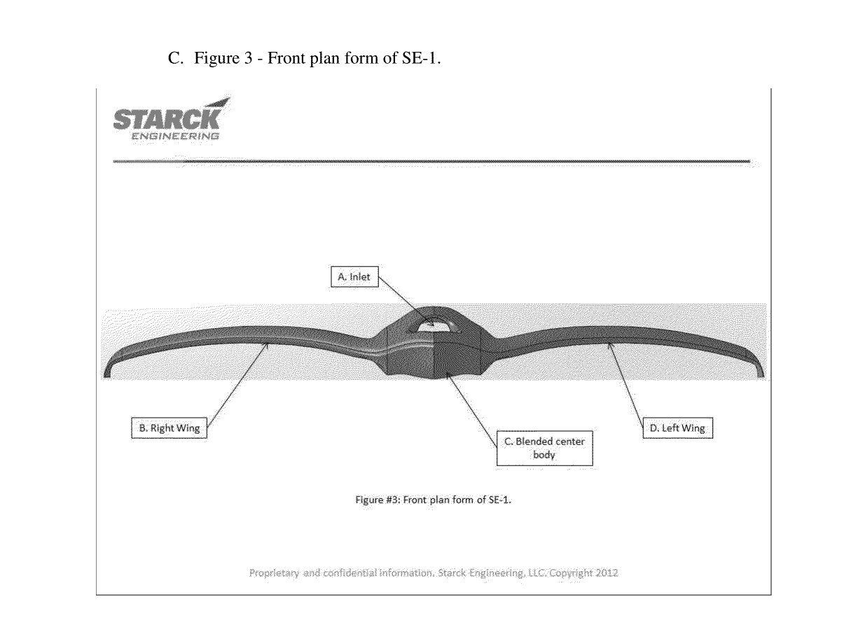

FIG. 3 is a perspective front view of the SE-1 in accordance with one example of the preferred embodiment of the present invention. (A) is an inlet of the preferred embodiment. (B) is a front-view of a right wing of the preferred embodiment. (C) is a front-view of a blended center body of the preferred embodiment. (D) is the front-view the left wing of the preferred embodiment.

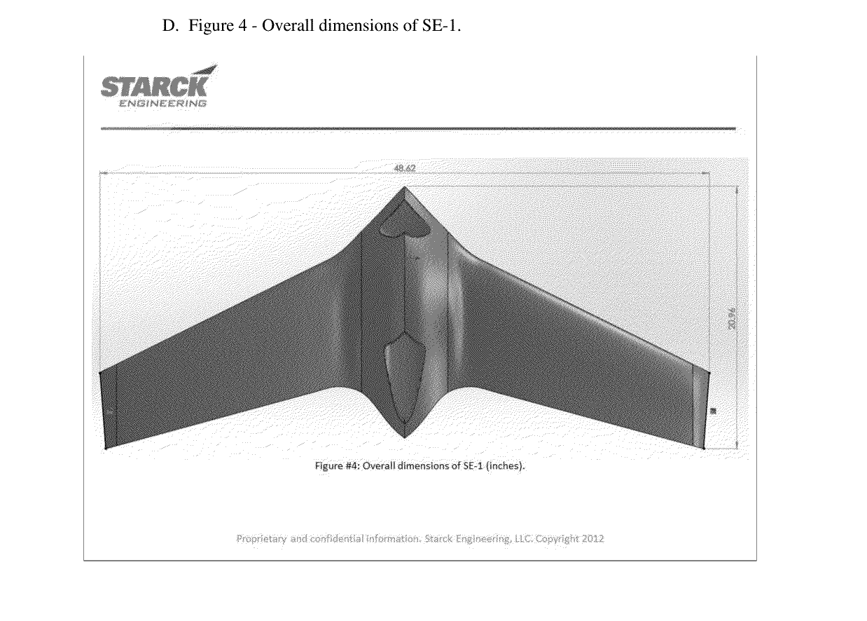

FIG. 4 is a preliminary dimensional layout of the SE-1 in accordance with one example of the preferred embodiment of the present invention with dimensions: (A) Length=forty-eight and sixty-two hundredths (48.62) inches. (B) Length=twenty and ninety-six hundredths (20.96) inches.

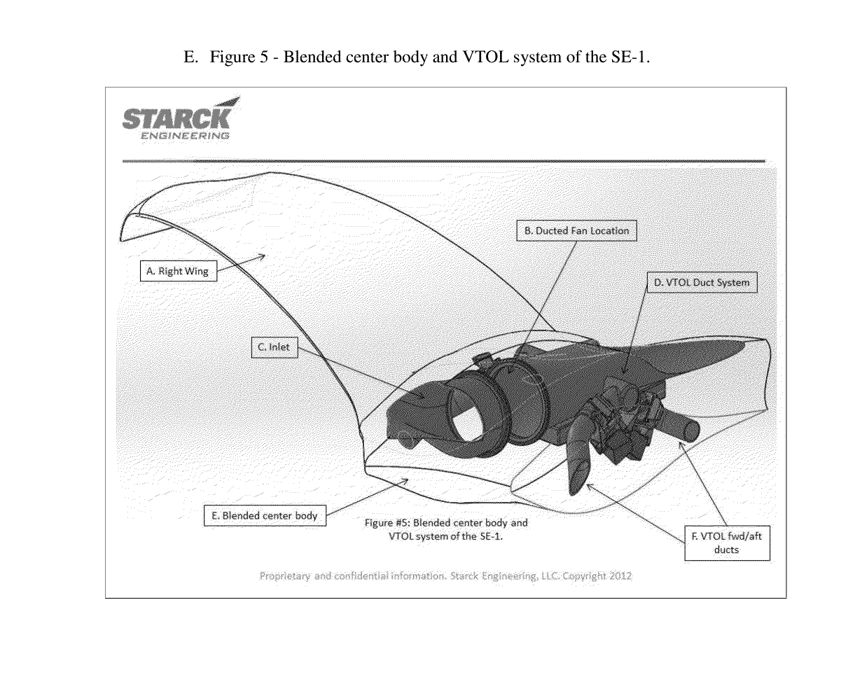

FIG. 5 is an illustration of the symmetric style center body section and location of the inlet and duct system in the center body of the SE-1 in accordance with one example of the preferred embodiment of the present invention. (A) is a view of the right wing of the preferred embodiment. (B) is the ducted fan location within the blended center body of the preferred embodiment. (C) is an inlet of the preferred embodiment. (D) is the VTOL duct system within the blended center body of the preferred embodiment. (E) is the blended center body of the preferred embodiment. To achieve a desirable lift to weight ratio for the SE-1, a blended body concept is proposed. A symmetrical airfoil shape for the center body section, large amounts of lift are achieved at very small angles of attack (Alpha). At a certain alpha point predicted by classic airfoil theory, flow separation, or stalling, will occur at an alpha of about 10 degrees. At this point, the center body section will not by an efficient lifting body. Using a blended body design allows the change of the vehicle cross section from a symmetrical airfoil in the middle of the body transitioning to an asymmetrical airfoil shape at the outer wing tip. Construction of the main body will consist of composite ribs and spars maintaining an open area in the center. The proposed outer skin will be a three ply stack-up of carbon fiber cloth and pre-impregnated tape giving the SE-1 is outer shape. The hollow center section allows for the ability to store large amounts of hardware and assorted sensor packages. (F) are the side view of the left wing VTOL forward and aft ducts of the VTOL system. The duct system is the basis of the SE-1 preferred embodiment's VTOL capability. The duct system is situated in the middle of the center body and consists of a ducted fan and five (5) outlet vents. The main outlet vent is the exhaust exiting out the aft portion of the invention. The remaining four (4) ducts are used for the VTOL capability existing of the underside of the SE-1 preferred embodiment. The construction of the duct system will be manufactured out of carbon fiber to reduce weight and increase strength while allowing manufacturing of complex duct shapes.

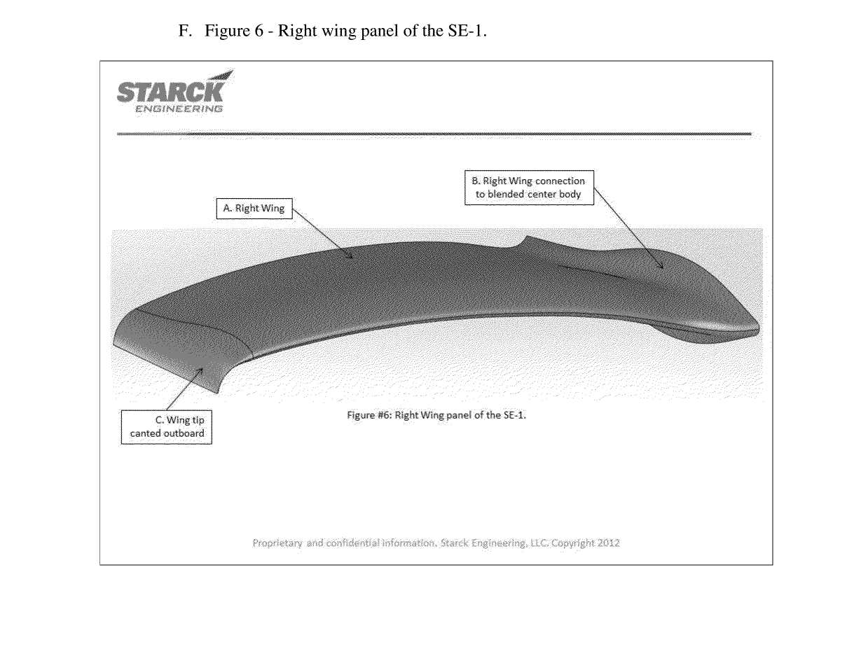

FIG. 6 is an enlarged perspective illustration of a wing panel. An anhedral wing design will increase the lifting surface area over the main wing sections. (A) a view of the right wing of the preferred embodiment. The wings are constructed in two outer sections and attached to the main body of the aircraft with dowel pins capable of transferring the bending, shear and axial loads usually encountered by aircraft of this type. Fabrication of the wings is done with machinable foam defining the shape of the airfoil cross-sectioned with three plies of carbon fiber cloth placed over the outer surface in a symmetric 45/0/45 layup. (B) a view of the right wing connection to the blended center body of the preferred embodiment. (C) is a view of the wing tip canted outboard of the preferred embodiment. To reduce instability problems inherent to a tailless aircraft, anhedral wings along with wing tips will be incorporated to improve yaw handling. The wing tips will be removable so as to allow changes in handling characteristics. This will be done to determine which length of wing tip adds the most handling capability. Designing turned down wing tips will function as a yaw stabilizer, thereby eliminated the need for a conventional vertical stabilizer and rudder. This feature will also reduce wing tip vorticity shedding and drag. This nonmetallic constructed SE-1 with a tailless shape, coupled with an anhedral wing, and canted downward wing tips will greatly minimize the RCS.

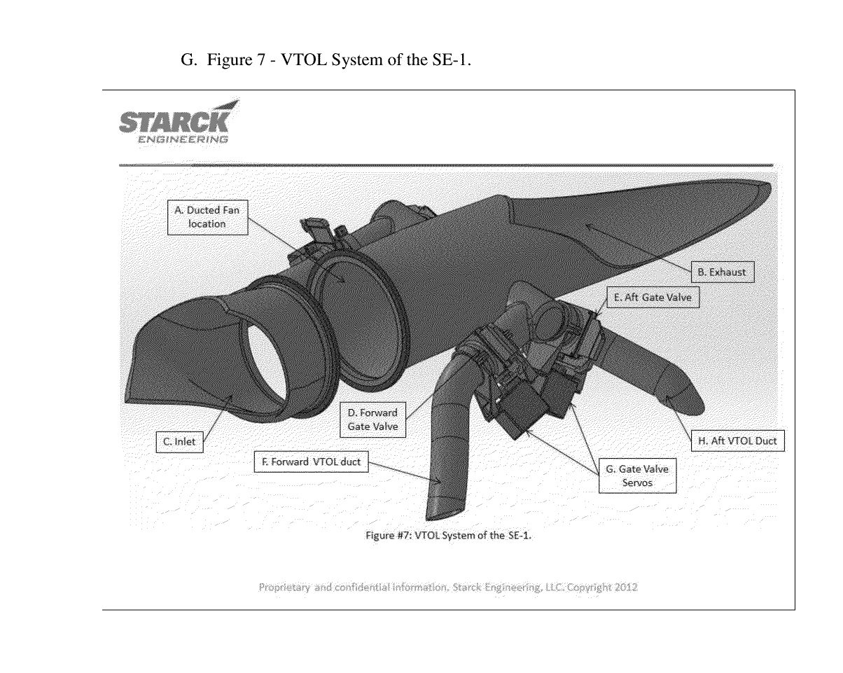

FIG. 7 is an enlarged perspective illustration of the duct system inlet configuration of the SE-1 in accordance with one example of the preferred embodiment of the present invention. The location of the inlet and duct system is a critical aspect of the SE-1 preferred embodiment. The duct system inlet is placed on the top surface of the body platform, close to the front of the nose of the SE-1 preferred embodiment. The location of the inlet greatly reduces the chance of ingesting any foreign object debris (“FOD”) during liftoff and landing. Placing the inlet opening close to the front nose allows the SE-1 to achieve higher angles of attack without introducing turbulent air inside the inlet. To prevent any turbulent air reaching the ducted fan, a gradual bend radius transitions the flow from the inlet. A clean laminar air flow into the ducted fan will greatly enhance the performance of the motor. Performance losses will result from turbulent air reaching the ducted fan causing a cavitation and loss of thrust. The inlet is a serpentine intake that precludes a direct line of sight of the fan blades. The power plant for the SE-1 is constructed of carbon fiber which will reduce weight and rotational mass of the impellers. The ducted fan is powered with a brushless electric motor which runs on a battery source. Aft of the ducted fan are two ports perpendicular to the air flow. These ports are used for the VTOL capabilities of the aircraft by diverting the flow from the exhaust nozzle. Control valves will distribute and direct the air flow evenly between the ports. A flow control valve is placed just aft of the exhaust to transfer all the air produced from the ducted fan and regulate the flow of air pursuant to the flight control system. (A) is a cross-view of a ducted fan location of the preferred embodiment. A ducted fan with a cross sectional area of a certain value will produce a certain thrust with an exit velocity required for lift and thrust. Maintaining the same size cross sectional area for the exhaust duct will produce the previously stated velocity. The inlet configuration layout resides inside the center body of the SE-1 preferred embodiment. The large mouth opening of the inlet allows the system to take advantage of the conservation of momentum by varying the duct size throughout the duct system of the SE-1 preferred embodiment. An engine that produces the thrust required at the exit of the ducted fan motor will only increase as the ducts are made smaller forming the VTOL nozzles. (B) is view of an exhaust of the preferred embodiment. (C) is a cross-view of the inlet of the preferred embodiment. (D) is a top view of a forward gate valve of the duct system of the preferred embodiment. (E) is a top view of an aft gate valve of the duct system of the preferred embodiment. (F) is a top view of a forward VTOL duct of the duct system of the preferred embodiment. (G) is a top view of a gate valve servo of the duct system of the preferred embodiment. (H) is a top view of an aft VTOL duct of the duct system of the preferred embodiment.

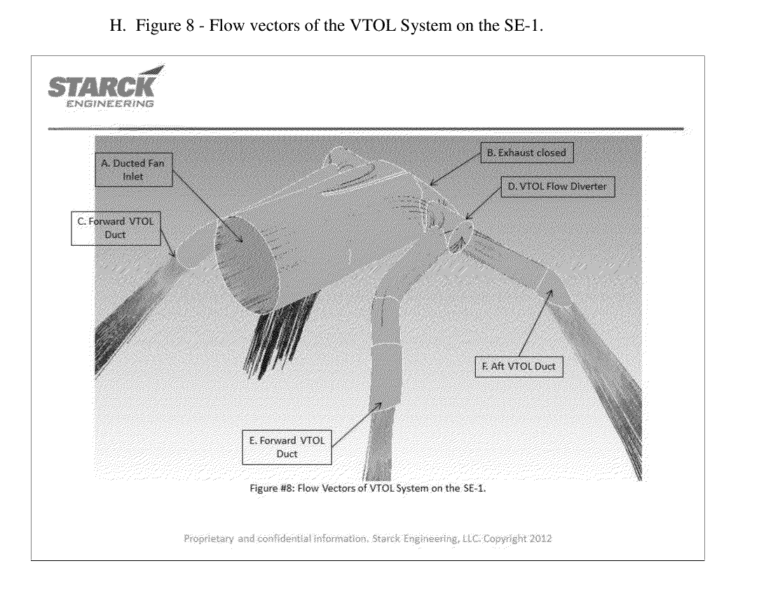

FIG. 8 is an illustration of the potential velocity contour vectors for an embodiment of the VOTL duct system of the SE-1 in accordance with one example of the preferred embodiment of the present invention. The velocity vectors in this figure show the flow being restricted from exiting out the exhaust and flowing down the four VTOL ducts. (A) is a ducted fan inlet location of the preferred embodiment. (B) is a view of the exhaust duct in the closed position for the preferred embodiment. (C) is a side view of a forward VTOL duct of the duct system of the preferred embodiment. (D) is a side view of a VTOL flow diverter of the duct system of the preferred embodiment. (E) is a side view of a forward VTOL duct of the duct system of the preferred embodiment. (F) is a side view of an aft VTOL duct of the duct system of the preferred embodiment. Just aft of the ducted fan are four (4) ports perpendicular to the flow. These ports are used for the VTOL capability of the SE-1 preferred embodiment by diverting the flow from the exhaust nozzle. To direct the flow evenly to all four nozzles located on the bottom of the SE-1 preferred embodiment will be flow control valves installed close to the entrance point. To transfer all the air produced from the ducted fan, a flow control valve will be placed just aft of the last set of VTOL ducts before the exhaust opening. This will force the air to flow down the four (4) ducts to the opening on the bottom of the SE-1 preferred embodiment. FIG. 8 are velocity contour vectors showing the flow being restricted from existing out the exhaust and flowing down the four (4) VTOL ducts. Upon completion of the flow design study, a structural analysis on the construction methodology will be done by performing a detailed finite element analysis (“FEA”) on the SE-1 preferred embodiment. A detailed 3D NASTRAN based finite element model (“FEM”) will be generated to optimize the wing skin thickness, ply stack up orientation, spar thickness size, and rib thickness in the center body. Using the NASTRAN PCOMP 2D lamination formulation with parametric modeling features of PATRAN will allow multiple iterations on the ply stack up orientation to be rapidly explored. To ensure proper loads are being imparted on the aircraft, a broad load spectrum will be explored to generate the highest feasible loads that might be encountered by the SRPA during flight testing.

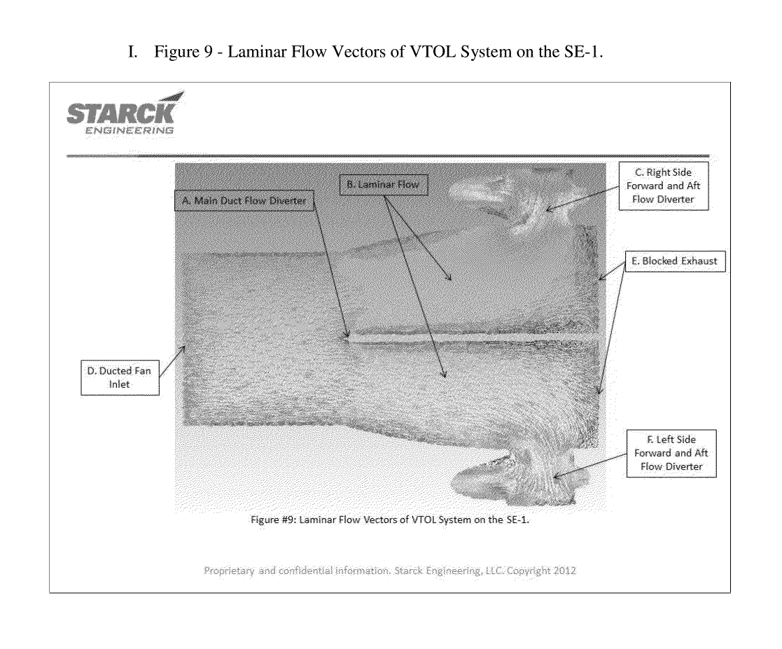

FIG. 9 is an illustration of the potential laminar duct inlet velocity vectors for an embodiment of the VOTL duct system of the SE-1 invention. (A) is a view of the main duct flow diverter of the SE-1 preferred embodiment. (B) is a laminar flow within the duct system of the SE-1 preferred embodiment. (C) is a right side forward and aft flow diverter of the duct system of the SE-1 preferred embodiment. (D) is a ducted fan inlet of the duct system of the SE-1 preferred embodiment. (E) are two blocked exhaust ducts of the duct system of the SE-1 preferred embodiment. (F) is the left forward and aft flow diverter of the duct system of the SE-1 preferred embodiment. To analytically determine the optimum flow rates for the inlet, exhaust, and VTOL ducts, a computational fluid dynamic (“CFD”) analysis will be performed before any hardware is manufactured. This will allow the design to be mature to the point where flow into the inlet is not turbulent and cavitation is prevented. This CFD analysis will optimize all the duct work located inside the SE-1 preferred embodiment. Maximizing and balancing the flow to all of the ducts is critical aspect of the SE-1 preferred embodiment. In addition, other CFD analyses will be performed to help determine the flight characteristics of the SE-1 preferred embodiment.

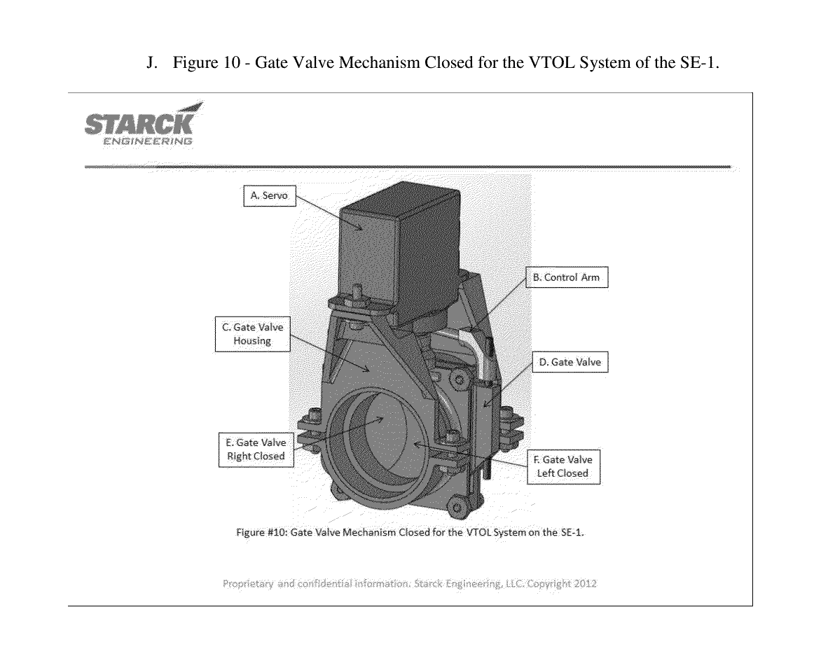

FIG. 10 is a gate valve mechanism in the closed position for the VTOL system on the SE-1 in accordance with one example of the preferred embodiment of the present invention. (A) is a standard servo with no specific significance that can be obtained at an electronics or hobby store. This servo element shall not be claimed as a distinctive or novel element of the SE-1. (B) is the custom control arm made of carbon steel or similar material of equal strength, weight and durability. The control arm shall be used to attach the servo control arm through a 90 degree coupler. The element also includes a custom plastic adaptor to transition the movement through a 90 degree coupler into the slider gate valve. (C) is the custom designed ABS plastic clam shell support housing for the mechanical servo. (D) is the custom designed linear sliding gate valve used to control the amount of air that passes through the entire assembly. There are two linear gate valves that slide parallel to each other closing off the air flow. (E) is the identified right side gate valve in the closed position. (F) is the identified left side gate valve in the closed position.

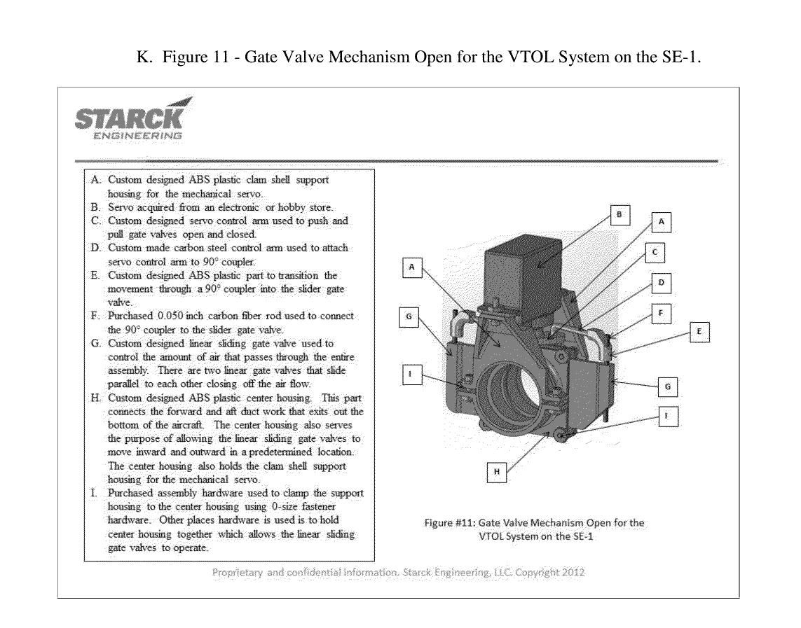

FIG. 11 is a gate valve mechanism in the open position for the VTOL system on the SE-1 in accordance with one example of the preferred embodiment of the present invention. (A) is a custom designed ABS plastic clam shell support housing for the mechanical servo. (B) is a servo acquired from an electronic or hobby store. (C) is a custom designed servo control arm used to push and pull gate valves open and closed. (D) is a custom made carbon steel control arm used to attach servo control arm to 90° coupler. (E) is a custom designed ABS plastic part to transition the movement through a 90° coupler into the slider gate valve. (F) is a 0.050 inch carbon fiber rod used to connect the 90° coupler to the slider gate valve. (G) is a custom designed linear sliding gate valve used to control the amount of air that passes through the entire assembly. There are two linear gate valves that slide parallel to each other closing off the air flow. (H) is a custom designed ABS plastic center housing. This part connects the forward and aft duct work that exits out the bottom of the aircraft. The center housing also serves the purpose of allowing the linear sliding gate valves to move inward and outward in a predetermined location. The center housing also holds the clam shell support housing for the mechanical servo. (I) is an assembly hardware used to clamp the support housing to the center housing using 0-size fastener hardware. Other placed hardware is used is to hold center housing together which allows the linear sliding gate valves to operate.

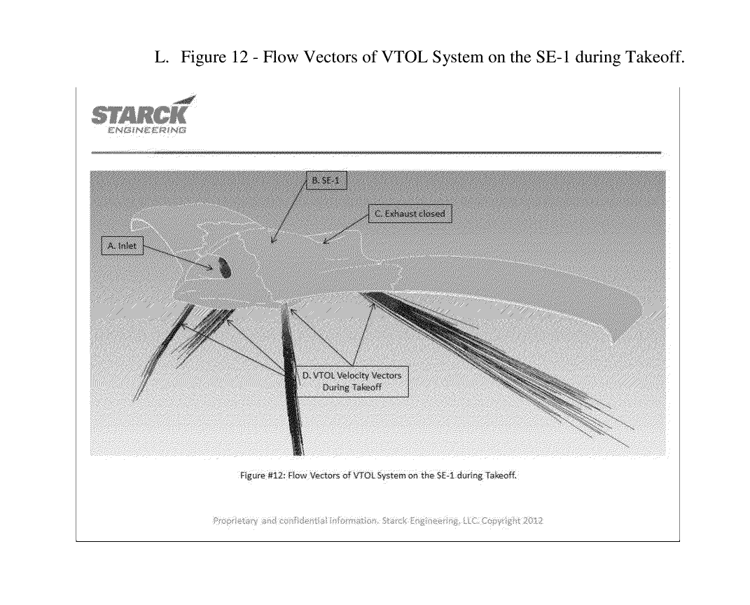

FIG. 12 is an illustration of the flow vectors and potential velocity contours of VTOL System on the SE-1 preferred embodiment during takeoff. (A) is an inlet of the SE-1 preferred embodiment. (B) is the SE-1 in accordance with one example of the preferred embodiment of the present invention. (C) is an exhaust duct of the duct system in the closed position of the SE-1 preferred embodiment. (D) is the SE-1 preferred embodiment VTOL velocity vectors during takeoff. To operate the SE-1 will require the operator to point the SE-1 into the direction of the wind. Following this procedure will allow the wind to flow over the SE-1 from the front to the aft adding stability and some lift during take-off. The SE-1 will be configured to close off the exhaust duct allowing all the air produced from the ducted fan to travel down the VTOL ducts. During the lift off phase to ensure the correct amount of thrust is being provided to each duct, a velocity probe will be placed at each exit. This data will be transferred to the flight control computer so nozzle opening corrections can be made. Monitoring the velocity data will ensure the SE-1 maintains a stable attitude during takeoff. In the event the SE-1 starts to rotate about its Z-axis, it will have the ability to adjust the correct VTOL nozzle flow to overcome the rotation. FIG. 12 analytically demonstrates the flow being produced from the VTOL ducts located on the bottom.

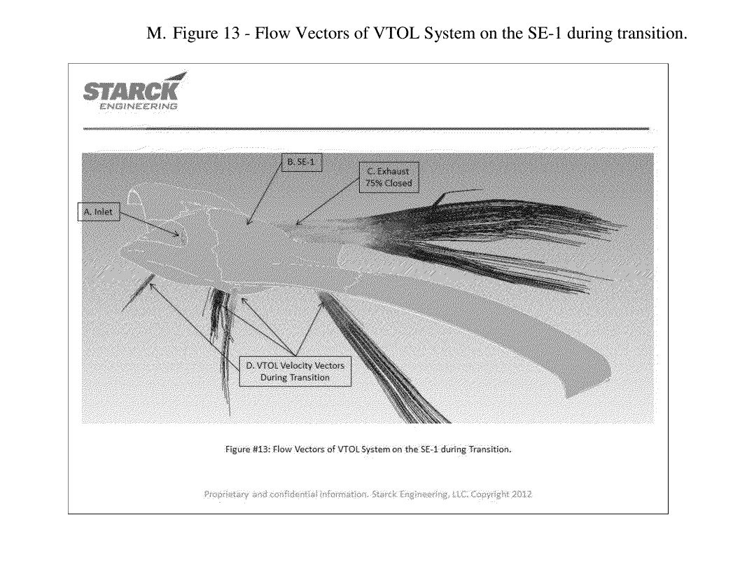

FIG. 13 is an illustration of the flow vectors and potential velocity contours of VTOL System on the SE-1 preferred embodiment during transition. The transition from hover to forward flight will utilize the flow control devices located inside each duct and exhaust nozzle. Once the aircraft is a safe distance off the ground, the adjustable nozzles will start to choke down on the VTOL ducts and open the exhaust duct. This transition will start to move the SE-1 forward and start producing lift. The point at which the aircraft has enough forward speed to generate enough forward lift will be determined from the CFD analysis runs. The point in time when the aircraft has enough forward lift the VTOL ducts will be completely closed and only the exhaust duct will be producing thrust. At this point, the remote pilot will take over flying the SE-1.

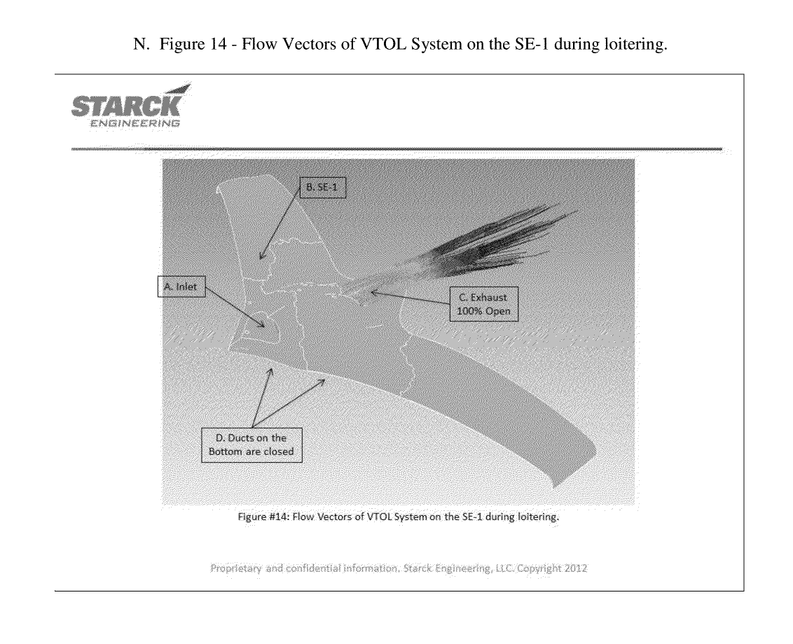

FIG. 14 is an illustration of the flow vectors and potential velocity contours of VTOL System on the SE-1 preferred embodiment during loitering. Using a high aspect ratio wing and blended body from the overall design has been shown from the CFD analysis to be very low drag aircraft during straight and level flights. This will allow the SE-1 to achieve a top speed of 105 mph based on the exit velocity calculations. This top speed will be reduced by a small amount after subtracting the drag values. The advantage of flying an aircraft this fast will allow the SE-1 to reach the target of interest quicker than most aircraft on the market. During loitering operations around the target when the SE-1 wants to conserve battery power to lengthen the mission, the VTOL vents can be used. With a high lift to weight ratio, the SE-1 can slow to 10 mph with an alpha of 12 degrees before stall occurs. Before the stall point happens, the VTOL ducts can be opened and the exhaust duct constricted. This will add vertical thrust to the bottom of the aircraft which will allow the aircraft to fly slower if required. The aircraft has now transitioned to a slow forward motion allowing the operator to monitor a slow moving target without having to circle.

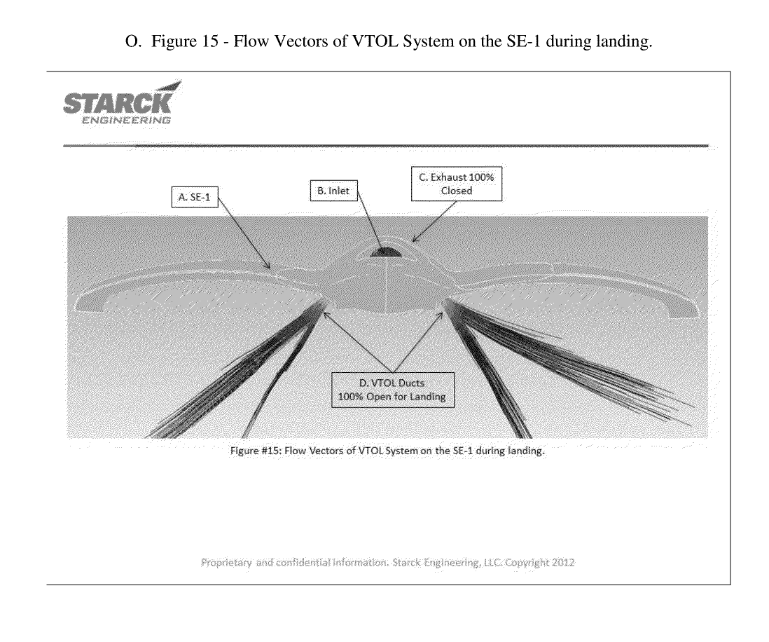

FIG. 15 is an illustration of the flow vectors and potential velocity contours of VTOL System on the SE-1 preferred embodiment during landing. The SE-1 shall perform a preprogramed landing sequence. This will involve the same technique used to hover the aircraft during loiter. The parameters that will have to be monitored during this critical event will be true air speed, wind speed and direction (determined at takeoff). In the event the wind direction changes during the flight, the operator will have the ability to send a signal indicating the change in wind direction to the on board computer. This value will be based on a compass heading which allows the GPS monitor on board to directionally point the nose of the aircraft. To achieve stable hover, the SE-1 will transition variable ducts quicker in order to prevent the SE-1 from losing lift. By designing the forward VTOL ducts, which not only point down, but also forward at a 45 degree angle will properly slow the aircraft to ensure a smooth transition to vertical flight. Preliminary calculations indicate a 40% forward and a 60% aft thrust level will be required during transition. The total thrust value will always be equal to 100% thrust, but during the transition period the exhaust thrust will be reduced while the VTOL ducts are initiated. The ideal thrust distribution for the VTOL vents is an equal distribution when the SE-1 forward flight speed is zero. Maintaining the configuration will allow the SE-1 to slowly and evenly descend to the ground. During the landing of the SE-1, a concern with exhaust ingestion will be eliminated, since the inlet is located on the top of the SE-1. This will minimize the chances of ingesting any debris that can damage the blades of the ducted fan impeller. The SE-1 design takes advantage of the platform layout to incorporate the landing gear into the body. With this swept wing design, the wing tips are in the line with the aft most portion of the airplane. This allows the use of the wing tips as landing gear skids. Located directly under the inlet on the centerline of the aircraft, a rounded protrusion makes a third landing point. This landing gear design will eliminate the use of retractable landing gear, add simplicity, and save on the weight and space of the SE-1.

We claim:

1. An aircraft comprising of:
a. vertical take-off and landing (“VTOL”) capabilities;
b. smaller than a standard manned aircraft;
c. remotely or autonomously piloted;
d. said aircraft comprising a symmetrical airfoil shape for a center body section;
e. said aircraft comprising a center body of a plurality of ribs and spars maintaining an open area in said center body;
f. a duct system situated in approximate middle of said aircraft body;
g. said aircraft body comprising a ducted fan and a plurality of outlet vents;
h. a main outlet vent being the exhaust exiting the aft portion of said aircraft;
i. remaining plurality of ducts used for the VTOL capabilities exiting the underside of said aircraft;
j. scaled size of said aircraft to satisfy needs and uses;
k. said aircraft comprising a blended wing body that further incorporates said inlet and duct system.

2. The aircraft of claim 1 further comprising:
a. blended center body to achieve a desirable lift to weight ratio;
b. a blended body design allowing the change of said aircraft cross section from a symmetrical airfoil in the middle of the body transitioning to an asymmetrical airfoil shape at the outer wing tip;
c. outer skin of said aircraft a plurality of ply stack-up carbon fiber cloth or similar product further including use of pre-impregnated tape;
d. hollow center section allows for the ability to store large amounts of hardware and assorted sensor packages;
e. and construction of said duct system manufactured from carbon fiber or similar product to reduce weight and increase strength while allowing manufacturing of complex duct shapes.

3. The aircraft of claims 1 and 2 further comprising:
a. an anhedral wing design to increase the lifting surface area over main wing sections;
b. said wings constructed in plurality of outer sections and attached to main body of said aircraft with dowel pins capable of transferring the bending, shear, and axial loads;
c. fabrication of said wings with machinable foam or similar product defining the shape of the airfoil cross-sectioned with multiple plies of carbon fiber cloth or comparable product placed over said wing outer surface in a symmetric layup;
d. and said wing tips are removable to allow changes in handling characteristics.

4. The aircraft of claims 1, 2 and 3 further comprising:
a. a duct system inlet being placed on the top surface of the body platform, close to the front of the nose of said aircraft;
b. a gradual bend radius transitions the flow from said inlet to prevent any turbulent air reaching said ducted fan;
c. said inlet is a serpentine intake that precludes a direct line of sight of duct fan blades;
d. power plant for said aircraft constructed of carbon fiber or similar product, which will reduce weight and rotational mass of said fan blades;
e. said ducted fan potentially powered with a brushless electric motor powered by a battery source;
f. said battery source aft of the ducted fan are two ports perpendicular to the air flow;
g. control valves to distribute and direct the air flow evenly between said ports;
h. a flow control valve placed aft of the exhaust to transfer all the air produced from said ducted fan and regulate the flow of air pursuant to the flight control system;
i. large mouth opening of the inlet allows said duct system to take advantage of the conservation of momentum by varying duct size throughout said duct system;
j. and an engine that produces thrust at exit of said ducted fan motor will increase as said ducts are made smaller forming the VTOL nozzles.
